(19) United States
(12) Patent Application Publication
(10) Pub. No.: US 2013/0059106 A1
(43) Pub. Date: Mar. 7, 2013

(54) Method and Apparatus for Producing Self-Adhesive Labels Using A Reusable Liner and Method of Producing and Applying Same

(71) Applicants: Maxime Bayzelon, La Prairie (CA); Francois Bayzelon, Chambly (CA); Frederic LaBrie, Boucherville (CA); Wei Xuan, Shanghai (CN)

(72) Inventors: Maxime Bayzelon, La Prairie (CA); Francois Bayzelon, Chambly (CA); Frederic LaBrie, Boucherville (CA); Wei Xuan, Shanghai (CN)

(21) Appl. No.: 13/600,479

(22) Filed: Aug. 31, 2012

Related U.S. Application Data
(60) Provisional application No. 61/530,148, filed on Sep. 1, 2011.

(51) Int. Cl. B32B 38/10; B32B 7/06; B32B 38/14; B32B 33/00

(52) U.S. Cl. 428/41.8; 428/343; 156/248; 156/510; 156/387

(57) ABSTRACT

The present disclosure relates to a method and an apparatus for producing self-adhesive labels. The method and apparatus laminate a liner-less facestock comprising self-adhesive labels to a reusable liner. The facestock has an adhesive side and a non-adhesive side. The adhesive side of the facestock is in contact with the reusable liner. Then, the facestock is cut around the self-adhesive labels. Waste facestock is separated from the reusable liner. The self-adhesive labels are extracted from the reusable liner, and the reusable liner is collected. A self-adhesive label product is also disclosed. The self-adhesive labels may be applied on receiving surfaces, for example on bottles, on cans, and the like.

### CROSS-REFERENCE TO RELATED APPLICATION

This application claims priority of Provisional Application 61/530,148 filed on Sep. 1, 2011.

### TECHNICAL FIELD

The present disclosure relates to the field of self-adhesive label manufacturing. More specifically, the present disclosure relates to a method and an apparatus for producing self-adhesive labels using a reusable liner.

### BACKGROUND

It is known in the art to apply printed self adhesive labels, also called adhesive-backed labels, to containers for products such as liquid soap and detergent, shampoo, food products and vitamins to name only a few. Self-adhesive labels are generally made in such a way as to require the removal of a “release paper” from the adhesive side of the label before it is applied to the container. Removal of the release paper exposes the pressure sensitive adhesive, permitting the label to be applied to the container. Slight pressure is then applied to create the adhesive bond.

The term “pressure sensitive adhesive,” as used herein, refers to an adhesive which bonds to an application surface as a result of applied pressure as opposed to the evaporation or absorption of a solvent to form a solid material bond.

Self adhesive labels and the like typically comprise the laminated combination of a printable facestock, a pressure sensitive adhesive on the back or reverse side of the facestock, a silicone layer and a liner, or backing paper, to which the silicone layer is relatively strongly bonded.

The liner may for example comprise paper, “glassine paper”, biaxially oriented polypropylene (BOPP), polyethylene terephthalate (PET), or other suitable filmic material. The liner is a material which, like the facestock, is available in rolls and accepts the silicone layer which helps producing the release effect. The laminated combination of the liner and cured silicone is referred to as a “release paper” or “release liner”.

Generally, self-adhesive labels are manufactured, printed and die-cut, in a first production plant and shipped on rollers to a second production plant where the labels are applied to receiving surfaces of containers, bottles and like devices. A significant component of the shipped product consists of release liner material, which is scrapped at the second plant, as labels are transferred from the release liner to the receiving surfaces. Such process results in an important waste of material which, in the case of glassine and of some other liner material, forms a significant share of the cost of materials involved in producing the labels.

Therefore, there is a need for self-adhesive label production and application techniques that reduce wastage of source materials.

### SUMMARY

In a first aspect, the present disclosure relates to a method for producing self-adhesive labels. A liner-less facestock having self-adhesive labels is laminated with a reusable liner. The facestock has an adhesive side and a non-adhesive side, where the adhesive side of the facestock is in contact with the reusable liner. The facestock around the self-adhesive labels is cut on the reusable liner. Waste facestock is separated from the reusable liner. The self-adhesive labels are extracted from the reusable liner, and the reusable liner is collected.

In another aspect, the present disclosure relates to an apparatus for producing self-adhesive labels. The apparatus comprises first and second feeders, a laminating unit, a cutting unit, a delaminating unit and a collector. The first feeder is adapted for feeding a liner-less facestock, where the facestock comprises self-adhesive labels, and has an adhesive side and a non-adhesive side. The second feeder is adapted for feeding a reusable liner. The laminating unit laminates the adhesive side of the facestock to the reusable liner. The cutting unit cuts the laminated facestock around the self-adhesive labels, on the reusable liner, and separates waste facestock. The delaminating unit extracts the self-adhesive labels from the reusable liner, while the collector collects the reusable liner.

In yet another aspect, the present disclosure relates to an apparatus for producing self-adhesive labels. The apparatus comprises a laminator of a liner-less facestock to a reusable liner. The facestock comprises self-adhesive labels and has an adhesive side and a non-adhesive side. As a result of lamination, the adhesive side of the facestock becomes in contact with the reusable liner. The apparatus also comprises a cutter of the facestock, on the reusable liner, around the self-adhesive labels, a separator of waste facestock from the reusable liner, an extractor of the self-adhesive labels from the reusable liner, and a collector of the reusable liner.

In a still further aspect, the present disclosure relates to a self-adhesive label product, comprising a reusable liner, a liner-less facestock having an adhesive side laminated to the reusable liner, and a series of self-adhesive labels cut from the liner-less facestock after the liner-less facestock has been laminated to the reusable liner.

### BRIEF DESCRIPTION OF THE DRAWINGS

Embodiments of the disclosure will be described by way of example only with reference to the accompanying drawings, in which:

FIG. 1 is an example of a method for applying self-adhesive labels; and

FIG. 2 is a schematic diagram of an apparatus for producing self-adhesive labels.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems of waste materials used in the production of self-adhesive labels. In an aspect, a labeling machine is supplied with a liner-less label roll, also called facestock, using an in-line reusable liner and an in-line die-cutting process before recuperating the reusable liner.

The following terminology is used throughout the present disclosure:
Self-adhesive: capable of adhering to an article without moistening.
Liner-less: of label material supplied without an underlying liner.
Facestock: base material for producing labels.
Reusable: can be used more than once.
Coat: a layer of a substance covering another.
Laminate: process of superposing layers of materials, also designating a resulting product of a lamination process.
Delaminate: separation of layers of a laminate.
Waste material: throw away material from a manufacturing process.
Extract: to separate an element from another element.
Collect: to accumulate an element in a single place.
Biaxially Oriented PolyPropylene (BOPP): a transparent form of polypropylene.
PET: polyethylene terephthalate, a common form of Polyester.
Filmic material: any polymer base material used to either produce a facestock or a liner.
Upper and lower sides: in the present disclosure, the lower side of a facestock is for adhesion onto a receiving surface while the upper side is opposite.
Transparent: capable of being seen through, whether or not completely clear.
Opaque: essentially not permitting a clear view therethrough, whether or not some light may traverse.
Label content: Image and/or text for printing on a label.
Pre-printing: printing on a label content on one or both faces of a facestock prior to winding of the facestock on a feeder roll.
Die-cutting: process of using a die to cut a low strength material.
Multilayer: material formed as a laminate of at least two layers of material.
Application surface, receiving surface: in the present disclosure, a surface intended for receiving a self-adhesive label.
Pressure sensitive: an adhesive that forms a bond with a receiving surface when pressure is applied thereon.
Feeder: device, for example a roller, for delivering a material.
Applicator: a device for applying a substance.
Workstation: a component of an apparatus for practicing a specific process;
Collector: a device, for example a roller, for accumulating an element in a single place.

Users of variants of the method and apparatus described herein may acquire liner-less rolls of facestock for the production of self-adhesive labels. The self-adhesive labels may be pre-printed on the facestock or a printing process on the facestock may be executed on a user's premises. Because the use of a liner is effective in producing labels, including in processes of cutting labels from a facestock and of transferring labels onto receiving surfaces, the liner-less facestock is laminated with a reusable liner. The facestock is then cut around the self-adhesive labels on the reusable liner. The facestock around the self-adhesive labels is afterwards separated from the reusable liner. The self-adhesive labels are then extracted from the reusable liner, and the reusable liner collected.

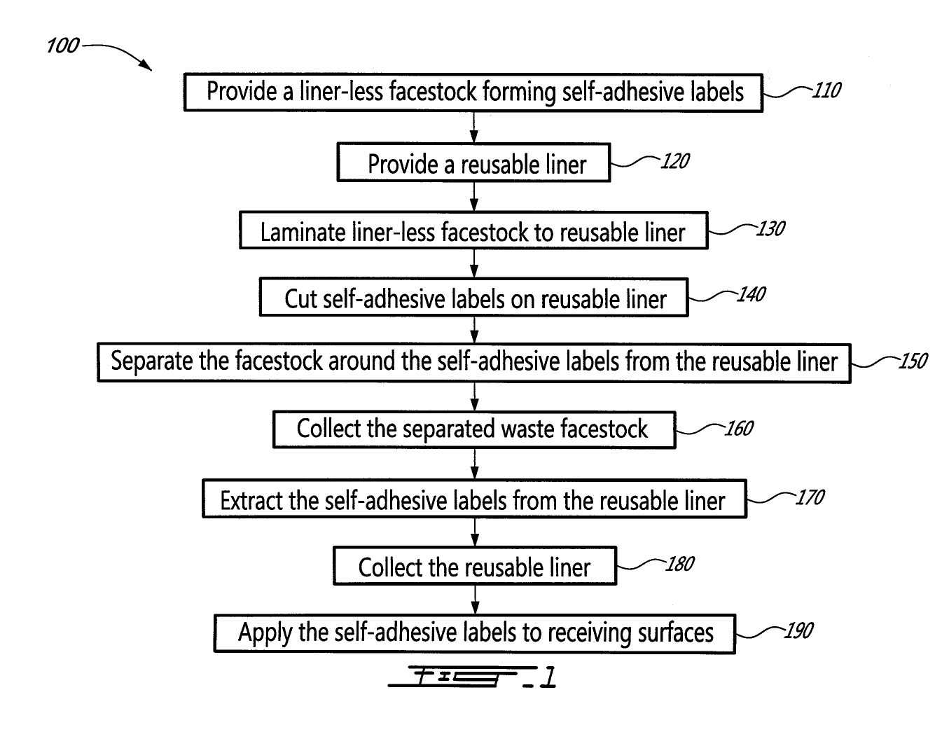

Referring now to the drawings, FIG. 1 is an example of a method for producing self-adhesive labels. The method 100 comprises providing a liner-less facestock at step 110. The liner-less facestock comprises an adhesive side (also called the bottom side) and a non-adhesive side (also referred as the top side). The adhesive may be pressure sensitive, whereby the self-adhesive labels become pressure sensitive labels. Various materials may be used for producing the facestock, including for example glassine paper, biaxially oriented polypropylene (BOPP), polyester (PET), or any suitable filmic material. The facestock may be a single layer or a multilayer facestock. The facestock may be pre-printed with label material or alternatively printed in line within an apparatus implementing the method 100. An optional printing step is not shown on FIG. 1. Printing may be performed on top of the facestock, on a bottom of the facestock, or on a combination of top and bottom. For example, if the facestock is substantially transparent, or translucent, the label material may be printed on any surface of the facestock. If the facestock is substantially opaque, printing a first label image may be made on the bottom of the facestock while a second label image may be printed on the top the facestock. Printing may be performed using various processes, including for example flexographic printing, gravure printing, silk screen printing, hot stamping, cold stamping, hot foil printing, cold foil printing, letterpress printing, rotogravure or offset printing.

The method 100 continues with providing a reusable liner at step 120. The reusable liner is coated, on at least one face, with a non-adhesive material, such as for example silicone. This non-adhesive material may be permanently applied on the reusable liner or may be re-applied thereon as part of the method 100; this optional step is not shown on FIG. 1.

The method 100 pursues at step 130 with laminating the liner-less facestock, which by then comprises the self-adhesive labels, to the reusable liner. More particularly, the adhesive side of the facestock is put in contact with the face of the reusable liner which comprises the non-adhesive material and laminated therewith. If the non-adhesive material on the reusable liner is not permanently affixed, application of a non-adhesive material may optionally be performed before proceeding with the laminating step 130.

The method 100 then continues at step 140 with cutting, on the reusable liner, the facestock around the self-adhesive labels. The cutting may be performed using for example a die cutting process. The facestock around the self-adhesive labels, also known as waste facestock material, is afterwards separated from the reusable liner at step 150. The separated waste facestock is collected at step 160. Then, the self-adhesive labels are extracted at step 170 from the reusable liner, and the reusable liner is collected at step 180.

The extracted self-adhesive labels may be transferred onto application surfaces, for example on bottles, cans, and the like, and applied thereon at step 190. As is well known in the art, transfer may be made by passing the self-adhesive labels, still attached to the reusable liner, on a roller having a narrow diameter or on a peeling plate, where the labels are less flexible than the reusable liner. The self-adhesive labels tend to detach from the reusable liner as the reusable liner is directed toward a collector at step 180.

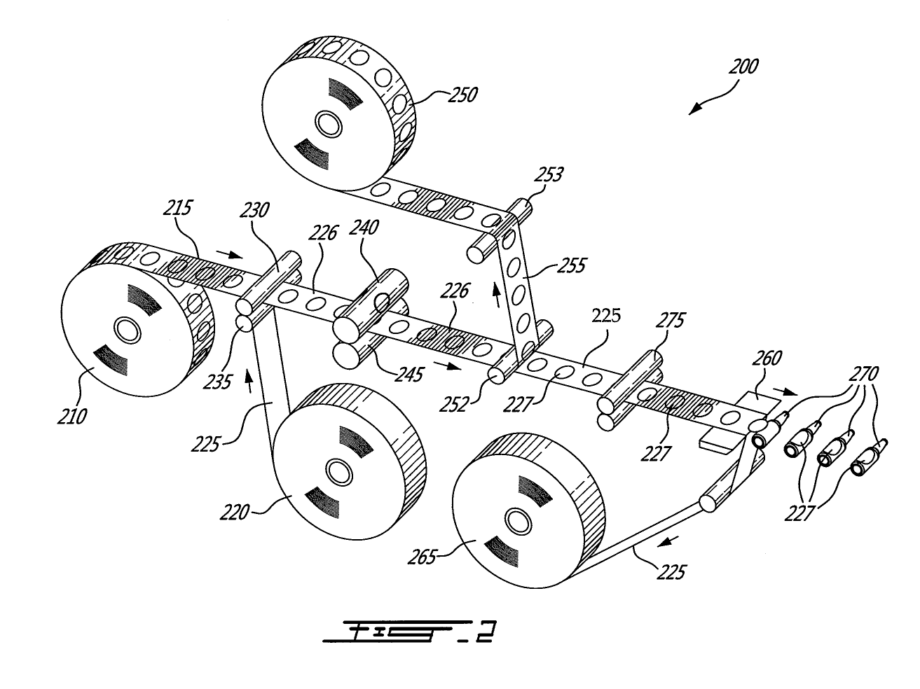

FIG. 2 is a schematic diagram of an apparatus 200 for producing self-adhesive labels. FIG. 2 is not to scale and does not include all components of a complete label manufacturing device. FIG. 2 is thus much simplified for ease of illustration. The apparatus 200 comprises a first feeder 210 for a liner-less facestock 215, a second feeder 220 for a reusable liner 225, a laminating unit, or laminator, comprising for example a rubber roll 230 and a hard roller 235, a cutting unit, or cutter, comprising for example a rotary cutting tool 240, which is a roller-shaped die, and a hardened anvil roll 245, a facestock collector 250 of waste facestock material 255, a delaminating unit 260, also called extractor, and a reusable liner collector 265 for collecting the reusable liner 225. Instead of the rotary cutting tool 240, the apparatus 200 may use a flatbed cutter (not shown).

The liner-less facestock 215 is supplied into the apparatus 200 by the first feeder 210 and proceeds through the apparatus 200 following a path indicated by arrows. The laminating unit, including the rubber roll 230 and the hard roller 235, laminates the bottom side of the liner-less facestock 215 on the face of the reusable liner 225 covered with a non-adhesive material, to form a laminated facestock 226.

The liner-less facestock 215 may be pre-printed or, in the alternative, a printer (not shown) may be present in the apparatus 200.

The rotary cutting tool 240 cuts the laminated facestock 226 around the self-adhesive labels on the reusable liner. To cut the laminated facestock 226, the rotary cutting tool 240 may be assisted by the anvil roll 245, the laminated facestock 226 being compressed between the rotary cutting tool 240 and the anvil roll 245, and only the facestock being cut and not the reusable liner. The facestock around the self-adhesive labels, also known as the waste facestock material 255 is separated from the reusable liner and collected on the facestock collector 250, if required with the help of a separator consisting for example of peel rollers 252 and of pull assist roller 253. Separation of the waste facestock material 255 around the self adhesive labels 227 from a liner is a well-known process and needs not be detailed further herein. In a variant of the apparatus 200, a pull cylinder 275 is used to maintain proper working tension for the rotary cutting tool 240 and for collecting the waste on the facestock collector 250. Following separation of the waste facestock material 255, before reaching the delaminating unit 260, a product comprising a series of self-adhesive labels 227 cut from the liner-less facestock 215 after the adhesive side of the liner-less facestock 215 has been laminated to the reusable liner 225 is obtained. The delaminating unit 260 then extracts, i.e. delaminates, the self-adhesive labels 227 from the reusable liner 225. The reusable liner collector 265 then collects the reusable liner 225.

A transfer unit (not specifically shown), either a part of the delaminating unit 260 or located aft thereof, may be used for transferring the self-adhesive labels on receiving surfaces, for example on bottles 270.

The reusable liner 225 collected on the reusable liner collector 265 is intended for reuse at the second feeder 220. In an embodiment, the reusable liner collector 265 and the second feeder 220 may be comparatively sized and shaped and be interchangeable, avoiding the need for re-spooling the reusable liner 225 from the reusable liner collector 265 onto the second feeder 220. In an alternative embodiment, the reusable liner collected at the reusable liner collector 265 could directly be fed to the second feeder 220.

Those of ordinary skill in the art will realize that the description of the apparatus and method for producing self-adhesive labels are illustrative only and are not intended to be in any way limiting. Other embodiments will readily suggest themselves to such persons with ordinary skill in the art having the benefit of the present disclosure. Furthermore, the disclosed method and apparatus may be customized to offer valuable solutions to existing needs and problems of producing self-adhesive labels.

In the interest of clarity, not all of the routine features of the implementations of the method and apparatus for producing self-adhesive labels are shown and described. It will, of course, be appreciated that in the development of any such actual implementation of the method and apparatus as disclosed, numerous implementation-specific decisions may need to be made in order to achieve the developer's specific goals, such as compliance with application-, system- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of label production having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for producing self-adhesive labels, comprising:
laminating a liner-less facestock comprising self-adhesive labels to a reusable liner, the facestock having an adhesive side and a non-adhesive side, the adhesive side of the facestock being in contact with the reusable liner;
cutting on the reusable liner the facestock around the self-adhesive labels;
separating waste facestock from the reusable liner;
extracting the self-adhesive labels from the reusable liner; and
collecting the reusable liner.

2. A method for producing and applying self-adhesive labels, comprising:
laminating a liner-less facestock comprising self-adhesive labels to a reusable liner, the facestock having an adhesive side and a non-adhesive side, the adhesive side of the facestock being in contact with the reusable liner;
cutting on the reusable liner the facestock around the self-adhesive labels;
separating waste facestock from the reusable liner;
extracting the self-adhesive labels from the reusable liner; and
collecting the reusable liner to produce the self-adhesive labels; and
applying the self-adhesive labels to receiving surfaces.

3. The method of claim 1 or 2, further comprising a step of collecting the waste facestock.

4. The method of claim 1 or 2, wherein the reusable liner is coated with a non-adhesive material.

5. The method of claim 4, wherein the non-adhesive material is silicone.

6. The method of claim 1 or 2, wherein the facestock comprises an element selected from biaxially oriented polypropylene (BOPP), glassine, paper, laminated paper, and polyethylene terephthalate (PET).

7. The method of claim 1 or 2, wherein the self-adhesive labels further comprises printed material on any of the following: a top of the facestock, a bottom of the facestock, both the top and bottom of the facestock.

8. The method of claim 1 or 2, wherein the facestock is any of the following: translucent material, opaque material, a combination of translucent and opaque material.

9. The method of claim 1 or 2, wherein the self-adhesive labels are printed on the facestock using one or several of the following processes:
flexographic printing, gravure printing, silk screen printing, hot stamping, cold stamping, hot foil printing, cold foil printing, letterpress printing, rotogravure and offset printing.

10. The method of claim 1 or 2, wherein cutting the facestock comprises a die-cutting process.

11. The method of claim 1 or 2, wherein the facestock is a multilayer facestock.

12. The method of claim 1 or 2, further comprising transferring the extracted self-adhesive labels onto application surfaces.

13. The method of claim 1 or 2, wherein the self-adhesive labels are pressure sensitive labels.

14. An apparatus for producing self-adhesive labels, comprising:
a first feeder for a liner-less facestock, the facestock comprising self-adhesive labels and having an adhesive side and a non-adhesive side;
a second feeder for a reusable liner;
a laminating unit for laminating the adhesive side of the facestock to the reusable liner;
a cutting unit for cutting the laminated facestock around the self-adhesive labels, on the reusable liner, and for separating waste facestock;
a delaminating unit for extracting the self-adhesive labels from the reusable liner; and
a collector for collecting the reusable liner.

15. The apparatus of claim 14, further comprising a facestock collector for collecting the waste facestock.

16. The apparatus of claim 14, wherein the reusable liner is coated with a non-adhesive material.

17. The apparatus of claim 16, wherein the non-adhesive material is silicone.

18. The apparatus of claim 14, wherein the facestock comprises an element selected from glassine, paper, laminated paper, polyethylene terephthalate (PET) and biaxially oriented polypropylene (BOPP).

19. The apparatus of claim 14, wherein the self-adhesive labels further comprises printed material on any of the following: a top of the facestock, a bottom of the facestock, both the top and bottom of the facestock.

20. The apparatus of claim 14, wherein the facestock is any of the following: translucent material, opaque material, a combination of translucent and opaque material.

21. The apparatus of claim 14, wherein the self-adhesive labels are printed on the facestock using one or several of the following processes: flexographic printing, gravure printing, silk screen printing, hot stamping, cold stamping, hot foil printing, cold foil printing, letterpress printing, rotogravure and offset printing.

22. The apparatus of claim 14, wherein the cutting unit is a die cutting machine.

23. The apparatus of claim 22, wherein the cutting unit comprises a rotary cutting tool.

24. The apparatus of claim 22, wherein the cutting unit comprises a flatbed cutter.

25. The apparatus of claim 14, wherein the facestock is a multilayer facestock.

26. The apparatus of claim 14, further comprising a transfer unit for transferring the extracted self-adhesive labels onto application surfaces.

27. The apparatus of claim 14, wherein the apparatus is configured to produce pressure sensitive labels.

28. An apparatus for producing self-adhesive labels, comprising:
a laminator of a liner-less facestock to a reusable liner, the facestock comprising self-adhesive labels and having an adhesive side and a non-adhesive side, the adhesive side of the facestock being in contact with the reusable liner;
a cutter of the facestock, on the reusable liner, around the self-adhesive labels;
a separator of waste facestock from the reusable liner;
an extractor of the self-adhesive labels from the reusable liner; and
a collector of the reusable liner.

29. A self-adhesive label produced using the method of claim 1.

30. A self-adhesive label product, comprising:
a reusable liner;
a liner-less facestock having an adhesive side laminated to the reusable liner; and
a series of self-adhesive labels cut from the liner-less facestock after the liner-less facestock has been laminated to the reusable liner.
